(19) United States
(12) Patent Application Publication
(10) Pub. No.: US 2010/0148673 A1
(43) Pub. Date: Jun. 17, 2010

(54) LED Replacement Light For Fluorescent Lighting Fixtures

(76) Inventors: Glenn Stewart, Carrollton, TX (US); Thomas O. Deans, Flower Mound, TX (US)

Correspondence Address: CARSTENS & CAHOON, LLP, P O BOX 802334, DALLAS, TX, 75380, US

(21) Appl. No.: 12/334,261

(22) Filed: Dec. 12, 2008

(51) Int. Cl. H05B 37/04; H05B 37/02

(52) U.S. Cl. 315/121; 315/294

(57) ABSTRACT

An LED replacement light for a fluorescent lighting fixture. The replacement light assembly includes a metal housing for heat dissipation and structural support. A standard plug for mating with the original lighting fixture connector is provided to allow direct replacement of an existing fluorescent light bulb. A control circuit having a power supply, a current controller, and a current sensor converts the fluorescent lamp power supply output to an output sufficient to drive the LEDs. The current controller generates a variable pulse width waveform for powering the LEDs, and a current sensor circuit regulates the flow of current through the LEDs. High-brightness LEDs are utilized and are spaced sufficiently apart to provide fewer point-sources of light while retaining overall equivalent luminance. A glare shield controls the light pattern emanating from the LEDs to direct the pattern illumination.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to illumination, and, more specifically, to control circuitry that powers an LED lighting device that allows the device to be utilized as a direct replacement for a compact fluorescent light bulb within the original compact fluorescent light bulb lighting fixture.

2. Description of Related Art Including Information Disclosed Under 37 CFR 1.97 and 1.98

The use of compact fluorescent lighting in cabinets and display cases is well known in the art. A typical application will utilize a fixture that supports a fluorescent bulb, such at a PL-13 type, at a level above the items to be illuminated. The power supply for the light is then oftentimes located at the base of the cabinet or case, with a supply wire routed to the lighting fixture. The power supply is then supplied with AC power from a typical AC power outlet or wired directly into an electrical utility panel containing switches and/or circuit breakers.

Ever since fluorescent lighting was introduced in workplaces, there have been complaints about headaches, eye strain and general eye discomfort. These complaints have been associated with the light flicker from fluorescent lights. Although humans cannot see fluorescent lights flicker at the 60 Hertz power supply rate, the sensory system in most individuals is still somehow capable of detecting the flicker. Further, fluorescent bulbs utilize phosphor coatings to influence the wavelength of light that is emitted. Still, the light emitted is “cooler” in that it features more blue and is typically less pleasing to the eye than standard incandescent or LED light sources.

Although such fluorescent light bulbs have a theoretical long life span (some reports indicate approximately 10,000 hours), failures occur much more frequently due to bulb and power supply issues. For example, the fluorescent bulbs require special ballast and starter devices that provide sufficient energy to create plasma within the bulb to cause it to glow. The high surges of current causes frequent failures of the ballast or starter devices. Replacement of these components usually requires disassembly of the cabinet or display case in which they are housed.

Although fluorescent bulbs can last approximately 10,000 hours, this, is significantly less than current LED technology. Illumination sources that feature LEDs can withstand over 60,000 hours of continuous use. Moreover, LED sources are not as prone to failure due to on/off switching. The fluorescent light bulb requires an initial high current surge to start illumination. This surge is not present in LED light sources.

Another drawback to the use of fluorescent lighting is that it provides diffuse, soft light patterns that lessen the radiance of illuminated jewelry. When used in a retail display case, the goal is to maximize the radiance to attract a potential buyer's attention. Current LED lighting solutions do little to accentuate the radiance given that most LED light strips utilize a high number of LEDs to achieve sufficient brightness. By providing such a high number of LEDs, the light generated becomes diffuse given the excessive number of point light sources (i.e., LEDs).

Accordingly, a need exists for a reliable LED light source that can retrofit current compact fluorescent light fixtures used in existing cabinets and display cases with little or no modifications to the existing, power supply. Further, a need exists for a retrofitting LED light source that accentuates the radiance of illuminated jewelry. The present invention satisfies this need and others as will become apparent after reading and understanding the detailed description below.

### BRIEF SUMMARY OF THE INVENTION

The present invention features an LED lighting device that connects to an existing G23-type fluorescent lighting connector. A novel control circuit design obtains AC power from the connector and converts the power to DC. The DC power is supplied to a pulse width modulation (PWM) controller that generates a signal pulse. This signal pulse is inductively coupled to create the drive voltage for an LED array. A comparator circuit senses the LED current and provides feedback to the PWM controller to regulate the light output.

The invention may be provided in a housing having space for the control circuit printed circuit board and components as well as the LED array. The housing has further protrusions for engaging the light in the original fixture and cooling fins for maintaining the internal temperature of the device.

These and other improvements will become apparent when the following detailed disclosure is read in light of the supplied drawings. This summary is not intended to limit the scope of the invention to any particular described embodiment or feature. It is merely intended to briefly describe some of the key features to allow a reader to quickly ascertain the subject matter of this disclosure. The scope of the invention is defined solely by the claims when read in light of the detailed disclosure.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a front elevational view of a display case employing lighting fixtures for lighting of the display case;

FIG. 2 is a bottom plan view of a conventional fluorescent lighting system for a fluorescent light, with the fluorescent lamp of the lighting system removed;

FIG. 3 is a cross-sectional view of the lighting system of FIG. 2 taken along the lines 3-3 and showing a socket of the fluorescent lighting system;

FIG. 4 is a bottom plan view of an LED lighting assembly that may be used for retrofitting in the fluorescent lighting system, such as that of FIGS. 2 and 3;

FIG. 5 is an elevational side view of the LED lighting assembly of FIG. 4;

FIG. 6 is an elevational end view of the LED lighting assembly of FIGS. 4 and 5;

FIG. 7 is an elevational side view of another embodiment of an LED lighting assembly that may be used with the lighting system of FIGS. 2 and 3;

FIG. 8 is an elevational end view of the LED lighting assembly of FIG. 7 with the lighting source of the LED lighting assembly being rotated relative to a base of the lighting assembly;

FIG. 9 is an elevational side view of another embodiment of an LED lighting assembly that may be used with the lighting system of FIGS. 2 and 3;

FIG. 10 is a schematic diagram of the control circuitry of an embodiment of the present invention;

FIG. 11 is a schematic diagram of the LED circuitry of an embodiment of the present invention;

FIG. 12 depicts a cross section of an additional embodiment of an LED lighting assembly featuring the elements of the present invention;

FIG. 13 depicts a perspective view of the additional embodiment; and

FIG. 14 depicts a cross section of the LED lighting assembly of FIG. 12 as it is installed and retained within a typical light fixture.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

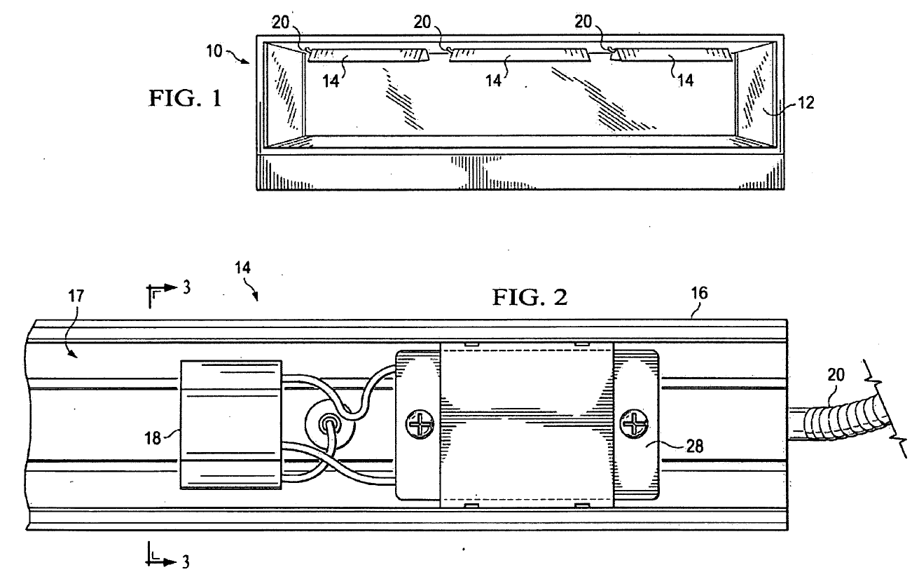

Referring to FIG. 1, a cabinet or display case 10, such those used in retail stores and the like, for displaying items or objects within the case 10 offered for purchase, is shown. The display case 10 is constructed with glass or transparent walls 12 for allowing objects within the case 10 to be readily seen. To facilitate viewing of objects within the case 10, one or more lighting systems 14 are mounted to or positioned within or near the case 10. The lighting systems 14 typically used are conventional fluorescent lighting systems that employ a fluorescent lamp or lamps. In the embodiment shown, the lighting systems 14 are mounted at or near the top of the display case.

While the lighting system or systems 14 described herein are shown being used for glass or transparent display cases, such as those used in retail stores, they can be used in a variety of other areas, such as for under-cabinet lighting in homes, offices, businesses, workspaces and the like, or anywhere lighting is desired, and should not be necessarily limited to any particular application or use.

FIG. 2 shows a more detailed view of the lighting system 14 with a fluorescent lamp of the lighting system 14 removed. The lighting system, 14 may be a preexisting lighting system for use with a compact fluorescent lamp (CFL) such as that used for PL-13 fluorescent lamps or other CFL fluorescent lamps. As used herein, “compact fluorescent lamp” or “CFL” or similar expressions refer to those fluorescent lamps or lighting systems wherein the fluorescent tube of the lamp is generally U-shaped or loop-shaped or the ends of the fluorescent tube return to generally the same end and are generally in close proximity to each other so that the lamp may be plugged into a single socket or plugged into a socket only at one end of the lamp or otherwise electrically coupled at one end of the lamp. Some examples of compact fluorescent lamps are described in U.S. Pat. Nos. 3,191,087; 4,199,708; 4,587,453 and 4,833,574, each of which is incorporated herein by reference.

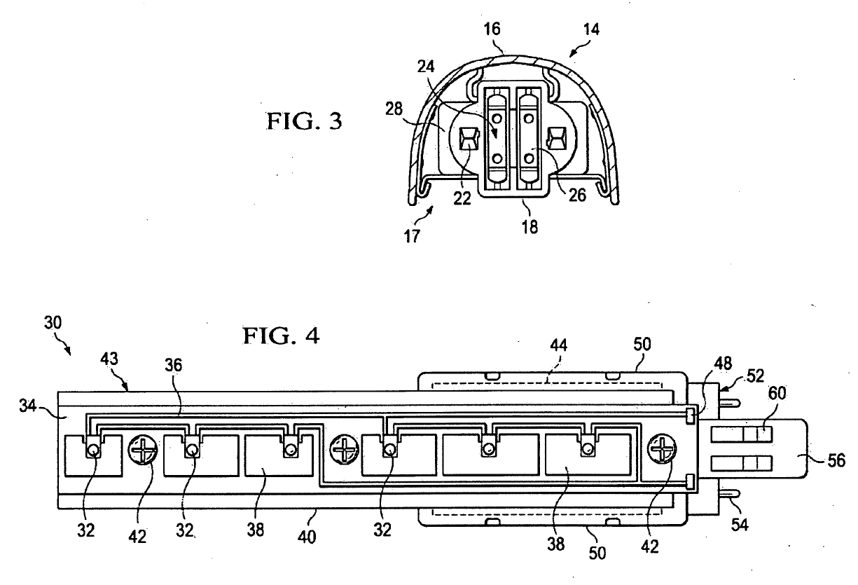

The lighting system 14 may include a shield or housing 16 for housing the lamp and other components of the system 14. The shield 16 may be formed as an elongate channel that is generally open along one side to allow the passage of light from the lamp (not shown) through the open portion 17 (FIG. 3) in a desired direction, and in some embodiments, preventing light from being directed in other directions. The shield 16 may have a generally U- or C-shaped transverse cross section, as shown in FIG. 3, and may be formed from any suitable material, such as metal, plastic, etc., which may be extruded, molded, or otherwise fabricated into the desired shape. The shield 16 may provide a sufficient housing and mounting device for other components of the lighting system 14. The shield 16 may provide an enclosure so that other components of the system 14 may be generally hidden when viewed from the exterior of the shield 16. An optional transparent or translucent cover (not shown), which may or may not be tinted, may be provided with the shield 16 to cover the open portion 17.

The lighting system 14 is provided with a light socket 18 that is electrically coupled to a power source through power cord 20. The power cord 20 may be provided with a plug (not shown) for plugging into an existing electrical outlet or may otherwise be hardwired to an electrical system sufficient for powering the lighting system 14. A control switch (not shown) for selectively powering the lighting system 14 may also be provided for turning the lamps on and off.

The socket 18 may be that configured for receiving a fluorescent bulb having GX23-type base and is provided with a pair of recessed or apertured electrical contacts 22 (FIG. 3) for receiving prongs of the fluorescent lamp (not shown). It should be noted that the socket 18 may be configured for receiving other fluorescent light bases as well, such as, but not limited to, G23-2, GX23-2, G24D-1, G24D-2, G24D-3, G24Q-1, G24Q-2, G24Q-3, GX24D-2, GX24D-3, GX24Q-1, GX24Q-2, GX24Q-3, GX24Q-4, 2G7, 2G11, 2GX7 and G23 bases. The socket 18 is provided with a recess 24 for receiving a corresponding projecting portion of the base of the PL-13 fluorescent light source. One or more clips or brackets 26 for releasable locking engagement with a corresponding mechanism of the PL-13 lamp base may also be provided. Much of the design and configuration of the socket 18 is to facilitate correct installment of the appropriate fluorescent lamp. Thus, one cannot install a fluorescent lamp into a socket unless it is specifically designed for it.

The socket 18 may be electrically coupled to the power supply through a ballast 28, which is typically used with fluorescent lamps, mounted to the shield 16 or otherwise incorporated into the lighting system 14. When used with a fluorescent lamp, the ballast 28 provides a level of initial voltage to ionize the gas mixture in the fluorescent light unit and then functions as a current limiter having an appropriate impedance to limit the current supplied to the fluorescent light unit to the appropriate value. As is discussed in more detail later on, a light-emitting diode (LED) lighting assembly used with the lighting system 14 is configured to operate with a ballast, such as the ballast 28, disposed in the power supply line, thus facilitating use of the LED light assembly with existing fluorescent lighting fixtures without requiring the ballast 28 to be modified or removed. In other embodiments, the ballast 28 may be removed or modified so that it is no longer coupled to the socket or incorporated into the power supply line. In this way, the LED lighting assembly may receive power directly through the regular line voltage, without the use of any ballast.

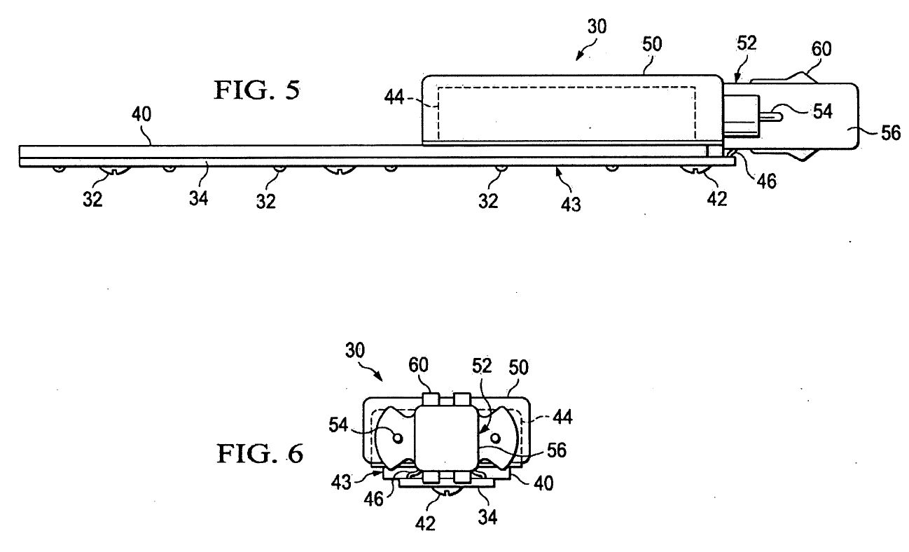

Referring to FIGS. 4-6, one embodiment an LED lighting assembly 30 for use with the lighting system 14 is shown. The lighting assembly 30 includes one or more LED light sources 32. The LED lights 32 may be constructed and formed from a variety of semiconductor materials to provide any desired color of light or wave frequency. LED light sources are known in the art and can be readily obtained commercially from a variety of sources. In certain embodiments, the LED lights 32 may be constructed to emit a white light, the same or similar to natural light. Other colors may also be used, such as blue, red, green, yellow and orange. LED light sources that emit ultraviolet or infrared light may also be used in certain applications.

The LED light sources 32 may provide from about 20 lumens/watt to about 150 lumens/watt per individual light source, with from about 40 lumens/watt to about 100 lumens/watt per light source being more typical. A light source providing about 80 lumens/watt has been found to be well suited for many applications. Examples, of commercially available LED light sources are the LUXEON.™. I and LUXEON.™. Rebel LED light emitters, available from Phillips Lumileds Lighting Company, San Jose, Calif. As shown in FIG. 4, there are six LED light sources that are mounted to an elongated panel 34 in a generally linear array or configuration. In certain embodiments, anywhere from one to about 10 or more light sources may be used, with from about 2 to about 8 LED light sources being typical. The light sources may be spaced apart from ½ inch to 2 inches or more, with from about ¾ inch to about 1.5 inches being typical. In the embodiment shown, the light sources 32 are linearly spaced apart approximately 1 inch along the length of the panel 34. The LED light sources may be arranged in non-linear, staggered or other configurations, as well. The LED light array may provide from about 400 to about 800 or more lumens, with from about 450 lumens to about 500 lumens being typical. An example of a suitable output for the LED light source array may be about 480 lumens. Lumen measurements may be measured at a distance of about 18 inches from the light sources.

It should be noted that the description and embodiments described are presented solely for the purpose of illustrating the invention and should not be necessarily construed as a limitation to the scope and applicability of the invention. In the description, each numerical value should be read once as modified by the term “about” (unless already expressly so modified), and then read again as not so modified unless otherwise indicated in context. Also, in the description, it should be understood that a value or range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific values within the range, or even points within the range, are explicitly identified or refer to only a few specific values, it is to be understood that the inventor appreciates and understands that any and all points or values within the range are to be considered to have been specified, and that the inventor is in possession of the entire range and all points within the range.

In the embodiment shown, the panel 34 is in the form of a generally flat printed circuit board (PCP) having circuitry 36 for supplying electrical power to each of the light sources 32. The circuitry 36 may electrically couple all or some of the light sources 32 in a series or parallel configuration. Additionally, one or more arrays or banks of several lights that are coupled in series may be wired so that the arrays or banks are in parallel or series and vice versa. In many instances, the light sources 32 will be electrically coupled in a series configuration. Pads, holes or other structures may be provided with the panel 34 to facilitate securing the LED lights 32, which may have corresponding pads, pins, etc., to the panel 34. Soldering or other securing means, which may be releasable or non-releasable, may be used to secure or couple the LED light sources 32 to the panel 34.

The panel 34 has a generally flat, rectangular shape, although other shapes and configurations, flat and non-flat, for the panel 34 may be used, as well. The length of the panel 34 is sufficient to provide the desired spacing for the LED light array. Thus, for example, for a linear array of four LED lights spaced approximately one inch apart, the panel may have a length of 5 to 6 inches. Provided in the panel 34 are heat pads or sinks 38, which may generally surround the, areas where the LED light sources 32 are secured. The heat pads 38 may extend through all or a portion of the thickness of the panel 34.

The panel 34 is secured or coupled in a closely abutting relationship to a heat transfer assembly 40. In the embodiment shown, the heat transfer assembly 40 serves as a heat sink and is a generally solid, rectangular-shaped member or plate formed from a heat conducting material, such as the metals of aluminum, copper, steel, etc., to facilitate heat transfer away from the LED light sources 32 and panel 34. Other configurations for the heat transfer member 40 may be used as well and these may correspond to fit in a close abutting relationship with the panel 34. Aluminum is particularly well, suited for the heat transfer member 40 because of its heat transfer properties and its lightweight. The heat pads 38 of the panel 34 may be in close or direct contact with the heat transfer member 40.

The panel 34 may be secured to the heat transfer member 40 through screws or fasteners 42. The screws or fasteners 42 may be of a highly heat conductive material and may pass through the thickness of the panel 34 and into the heat transfer member 40 to facilitate heat transfer from the panel 34 to the plate 40. The fasteners 42 may also pass through the heat sinks 38 of the panel 34. The combined panel 34 with the light sources 32 and heat transfer member 40 form an elongated LED lighting strip 43. An optional transparent or translucent cover (not shown) may be provided with the LED lighting strip for covering of the LED lights 32.

The amount of heat transferred away by the heat transfer member 40 and components of the LED light assembly 30 should provide sufficient heat transfer so that the assembly is generally maintained at a temperature at from about 25 F to 60 F above the ambient temperature.

The LED light assembly 30 includes a current converter 44. The current converter may be, in the form of an LED power driver for converting power or, electrical current from a high power supply, such as a standard 100V to 120V AC current, through the power cord 20 and any existing ballast, such as the ballast 28, to provide an appropriate electrical output for powering the LED light sources 32. The input voltage may be, for example, from about 50V to about 300V, although the input voltage may vary. The electrical output from the current converter 44 may be a low voltage DC current, which may include a 5 V, 10V, 12V, 24 V or 27V DC current for powering the LED light sources 32. The output current from the current converter may be from about 200 mA to about 1 Amp, with from about 350 mA to about 750 mA being typical. An example of a suitable LED power driver is that commercially available as the Xitanium LED Driver, Model No. LEDUNIA700C12F, from Advance Transformer, Rosemont, Ill., which may provide an 8 Watt, 700 mA current output.

Other current converters may also be used to provide a suitable current to the LED light sources. Some elements of the light assembly 30 may be configured to operate on an AC power supply while others a DC. In some embodiments, the current converter may include a controller in the form of hardware, software, firmware or a combination thereof for driving the LED light source assembly 30 at a desired duty cycle. For example, in some embodiments, the current converter may cause illumination or activation of the LED light sources according to a predetermined intermittent rate, such as a pulsed or intermittent activation of the LED lights.

The output of the converter 44 may be electrically coupled through wires 46 to the circuitry 36 of the PCP 34 through contacts 48 (FIG. 4) of the PCP 34. Other electrical coupling means may also be used. The converter 44 may be housed in a driver housing 50 sized and configured for receiving the converter 44. The housing 50 may be mounted to the panel 34 and/or heat transfer member 40 by means of fasteners, such as the fasteners 42. Other fastening or mounting means, such as gluing, bonding, welding, molding, etc., may also be used to mount the housing 50 and converter 44 to the lighting strip 43.

A base 52 may be incorporated with the housing 50 or may otherwise be electrically coupled to the converter 44 and LED lighting strip 43. In the embodiment shown, the base 52 is configured to correspond to the existing socket 18 of the lighting system 14. Accordingly, the base 52 is configured to generally correspond to a GX23-type base. The base 52 may have other configurations as well to correspond to differently configured sockets. Thus, the base 52 may also be configured to correspond to sockets for G23-2, GX23-2, G24D-1, G24D-2, G24D-3, G24Q-1, G24Q-2, G24Q-3, GX24D-2, GX24D-3, GX24Q-1, GX24Q-2, GX24Q-3, GX24Q-4, 2G7, 2G11, 2GX7 and G23 bases as well as other bases.

Asia GX-23-type base, the base 52 includes a pair of transversely spaced apart prongs or projecting electrical connectors 54 for being received and making electrical contact with the recessed or aperture contacts 22 of the socket 14. The prongs are electrically coupled to the converter 44 through wires (not shown) or other electrical coupling means to provide current from the power cord 20 and/or ballast 28 to the LED lights 32.

Additionally, the base 52 is provided with a male projecting socket engagement member 56 that is received and corresponds to the recess 24 of the socket 24. The member 56 is formed from a generally blocked-shaped portion that carries a single or pair of upper and lower ramped locking or engagement members 60 that releasably engage the bracket or brackets 26 of the socket 24. The configuration of the base 52 may vary, however. The base 52 may facilitate mounting of the lighting assembly, 30 to the lighting, system so that no further means is required to hold the lighting assembly 30 in place other than insertion of the base 52 into the socket 18. Further securing means may be provided, however, if desired. A universal base may also be configured so that the base 52 can be installed into a number of different sockets having different configurations. This may be accomplished by elimination or modification of the projecting member 56.

The components of the LED lighting assembly 30 are configured so that the entire lighting assembly 30 fits easily into and is housed within the shield 16 of the lighting system 14. If any transparent or translucent cover (not shown) is provided with the shield 16, the LED lighting assembly may be configured so that it readily fits behind such cover, as well. The entire length of the LED lighting system may be from about 2 inches to about 10 or 12 inches and may have a width across its greatest transverse dimension of from about ¾ inch to about 2 or 3 inches.

In use, the LED lighting assembly 30 merely replaces any existing fluorescent or other lighting assembly that is being used with the lighting system 14. One merely disengages and removes such existing lighting assembly from the socket 18 and replaces it with the LED lighting assembly 30 by merely inserting the base 52 into the socket 18 so that the prongs 54 are in contact with the contacts 22. As current is supplied from the power cord 20 and/or ballast 28, it is modified by the current converter to power the LED light sources 32 to provide light to the display case 10 or other areas for which the light system is being used. There is no need to modify or otherwise configure the lighting system 14 differently to accept the LED lighting assembly 30. The lighting assembly 30 is completely self-contained and requires no additional parts or modification to work with the existing fluorescent lighting system 14.

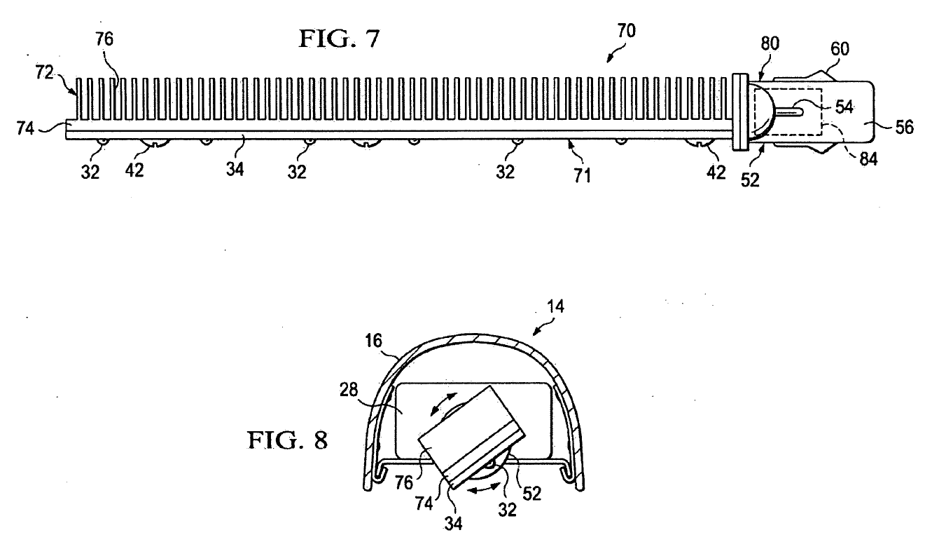

FIGS. 7 and 8 illustrate another embodiment of a LED lighting assembly 70. The LED lighting assembly 70 is similar to the assembly 30, with similar components labeled with the same reference numerals. The assembly 70 differs from the assembly 30 in that the lighting strip 71 is provided with a heat transfer assembly 72 that includes a planar member or plate 74 like the member 40 that includes a plurality of longitudinally spaced apart heat transfer surfaces or fins 72 that extend from the surface of the plate 74 opposite the panel 34 across all or a portion of the width of the plate 74

Additionally, the lighting strip 71 is rotatably mounted to a base 80 so that the lighting strip 71 may be rotated about a longitudinal axis, as indicated by the arrows in FIG. 8, when the base is secured within a corresponding socket, such as the socket 18. This allows the light from the lighting strip 71 to be focused to different orientations without adjusting or rotating the shield 16 or lighting system 14. The lighting strip 71 may be rotated continuously with the strip 71 be held in any position when rotated 360 degrees to provide an infinite number of positions or it may be provided with a releasable locking mechanism so that it can be rotated to a few or a limited number of positions.

The LED lighting assembly 70 also differs in that the power driver 44 is eliminated and instead an integrated circuit (IC) chip 84 is used to convert the current to the appropriate levels for use with the LED lighting strip 71. The IC chip 84 may be housed within the base 80, which may be hollowed to house the IC chip, and is electrically coupled to the circuitry of the lighting strip 71 and the prongs 54 of the base. Examples of suitable commercially available IC chips for current conversion include the VIPer22A and VIPer22A chips, available from STMicroelectronics, which include an integrated current mode PWM and a high voltage power MOFSET on the same chip.

The LED lighting assembly 70 is used in a similar manner to the lighting assembly 30 and is merely plugged into an existing socket of a lighting system, as described with respect to the lighting assembly 30.

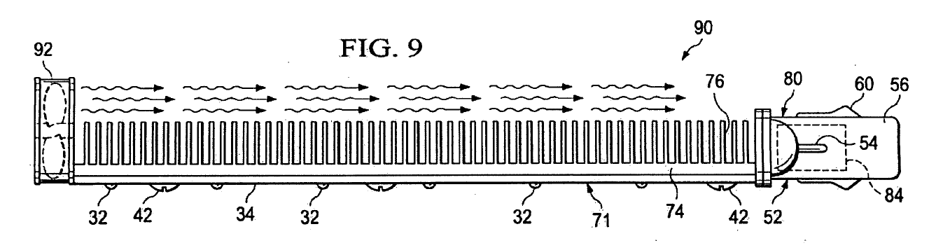

FIG. 9 shows another embodiment of an LED lighting assembly 90. The lighting assembly 90 is similar to the lighting assembly 70 previously described, with similar components labeled with the same reference numerals. The LED lighting assembly 90 further includes a small electric fan 92, such as those CPU fans used with computers and the like, incorporated with lighting strip 71. The fan 92 is electrically coupled to the prongs 54 so that power is directed to the fan 92 from the same power source when the assembly 90 is plugged into the light socket 18.

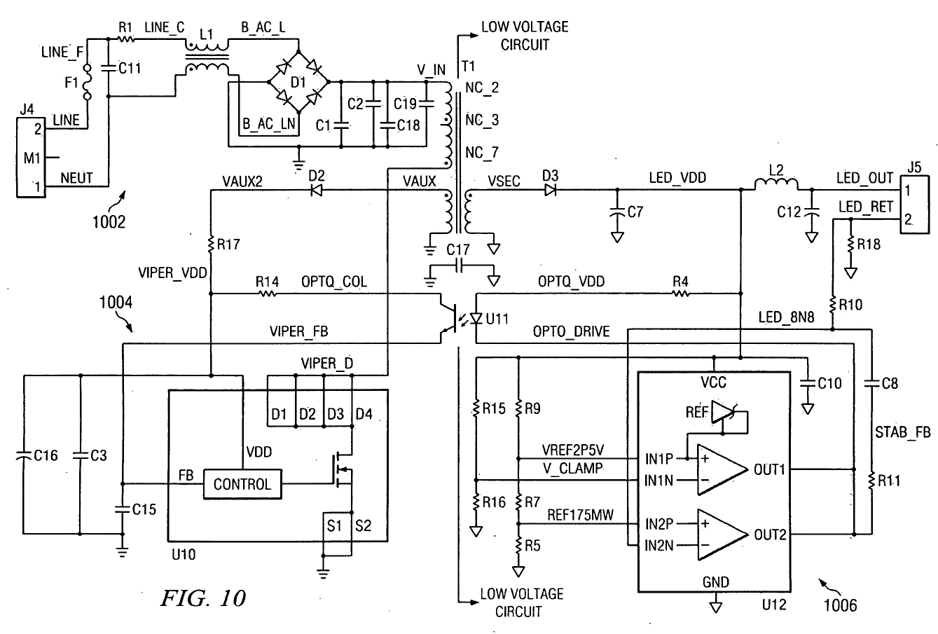

FIG. 10 depicts a schematic diagram of the control circuitry of the present invention. To allow the power supply for a fluorescent light to power an LED requires a novel combination of electrical components, given the starkly different power requirements for both. The novel control circuitry includes an AC to DC power converter (1002), a PWM drive current controller (1004), and an LED current sensor (1006).

With reference to FIG. 10, a jack (J4) is provided to connect with the fluorescent lighting fixture in the same manner as the fluorescent bulb. This jack (J4) permits power from the fluorescent lighting fixture to be utilized by the control circuit assembly. In this embodiment, the LED lighting assembly utilizes a PL-13 type connector that mates with a GX23-type socket. However, one skilled in the art will appreciate that other fluorescent lighting connectors (such as those previously indicated) may be utilized as well and are within the scope of the present invention.

AC power from the jack (J4) is first conditioned and converted to DC. Bridge rectifier D1 rectifies the AC to provide DC power to drive the PWM drive current controller (1004). Filter capacitors C1, C2, C18, and C19 remove the ripple voltage felt at the output of the converter (1002) due to operation of the PWM drive current controller (1004). In the present embodiment, four precision film capacitors are utilized, each having a capacitance of 1 microfarad.

Given the longevity of the LED light (approximately 60,000 hours), it is necessary to ensure essentially equal longevity of the control circuitry. Further, to survive in the high heat environment (approximately 60 degrees Centigrade or more) of the LED light fixture, the control circuitry must be heat tolerant as well. For these reasons, film capacitors were chosen for C1, C2, C18, and C19, given the film capacitor's stability and longevity in relation to other capacitors such as aluminum electrolytic. Further, four such capacitors were chosen to reduce the overall space required in the housing cavity.

The power converter (1002) also features use of a common mode choke (L1 and C11) near the input. Given the PWM output from the PWM drive current controller (1004), substantial high frequency noise is felt throughout the control circuitry. The common mode choke (L1 and C11) suppresses this high frequency noise to reduce the EMI emissions from the control circuitry. A resistor (R1) is provided to control surge current when power is first applied.

The PWM drive current controller (1004) in the present embodiment utilizes a current mode PWM controller (U10) such as VIPer22A chip as previously mentioned. DC power from the converter (1002) is applied to the drain circuitry (D1-D4) of the controller (U10). As the controller (U10) operates, it generates a PWM 60 kHz square wave output. The primary winding of the isolation transformer (T1) couples this alternating current to two separate secondary windings (VAUX and VSEC). The “VAUX” winding step's down the voltage to provide the proper drive voltage (VDD) to the PWM controller (U10), while the “VSEC” winding provides power for the LEDs.

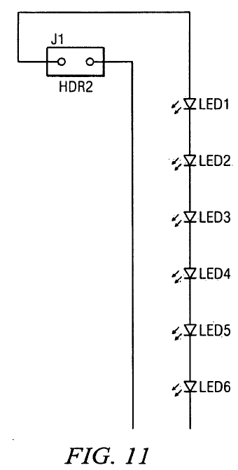

The PWM controller (U10), when operating, generates a square wave that is inductively coupled to the secondary windings (VSEC) to power the LED current controller (1006). A rectifier diode (D3) blocks any negative voltage component while inductor/capacitor filter circuitry (L2/C12) provide filtering. This DC power is then passed onto the LEDs via another jack (J5) that is connected to the LED circuitry of FIG. 11.

Referring to FIG. 11, a schematic is depicted of the LED circuitry in the present embodiment DC power from the control circuitry enters the LED circuit via yet another jack (J1). This power is then distributed to a plurality of LEDs (LED1-LED6 as depicted), each of which is connected in series. It will be readily appreciated that the number of LEDs may vary from that shown in the present embodiment, such that at least one but more than six may be utilized.

In the present embodiment, the LEDs (LED1-LED6) are connected in series. Given that the voltage drop across a conducting diode is essentially constant, each of the resulting voltage drops is additive in this configuration. However, a parallel arrangement may be utilized as well. A parallel configuration of LEDs would allow for illumination even with failure of one or more (but not all) LEDs whereas the series configuration would cause all LEDs to cease functioning upon such failure. Also, a parallel arrangement would change the voltage and current limiting requirements that the LED current sensor (1006) must provide. Still, either configuration is within the scope of the present invention.

Referring again to FIG. 10, the LED current controller (1006) utilizes a comparator and voltage clamp circuit (U12) to regulate the current supplied to the LEDs. In this embodiment, the current is regulated to a constant 350 mA. As current flows through the LEDs, a voltage drop is felt across the current sense resistor (R18). This voltage drop is monitored by the comparator circuit (U12) which generates a feedback signal in response. If the LED current is too great (i.e., voltage drop across the sense resistor R18 is too large), the LED current sensor (1006) provides appropriate feedback to the PWM current controller (1004) to shorten its PWM output and reduce the power to the LEDs. Conversely, if the LED current is too low the feedback to the PWM current controller (1004) causes the PWM controller's output to increase to supply more current to the LEDs.

Feedback generated by the comparator (U12) is transmitted to the PWM controller (U10) via an optical isolator device (U11). Use of such a device provides transient voltage isolation from the line voltage side of the circuit for safety purposes. In this manner the output of the comparator (U12) may directly affect the feedback current to the PWM controller (U10) to cause the PWM controller output to vary in response, causing a subsequent response in the LED current.

The voltage clamp (U12) provides protection in the event of an LED failure. If an LED in a serial configuration were to fail open, no current could flow. The response of the LED current drive circuitry (1006) would be to increase the voltage output in an attempt to force current through the open LED circuit. The voltage clamp (U12) limits the voltage to a fixed level to prevent an overvoltage condition. In the present embodiment, the clamp limits the voltage at the secondary (VSEC) to 30 volts.

As seen in FIG. 10, the isolation transformer (T1) and the optical coupler (U11) serve to isolate the high voltage circuitry (1002 and 1004) from the low voltage circuitry (1006). This is important given the conditions in which the LED lighting assembly is utilized.

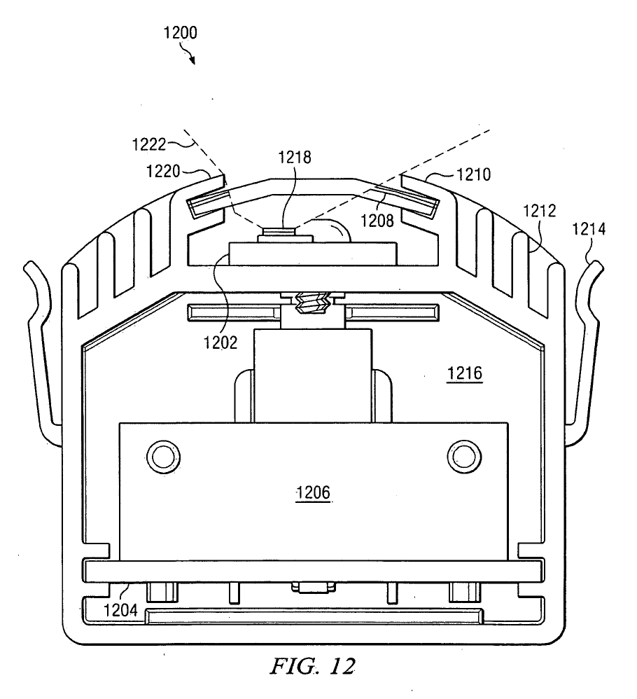

FIG. 12 depicts a cross section of yet another embodiment of the present invention. In this figure, it is shown an extruded LED lighting assembly (1200). The extrusion features a rectangular hollow center section (1216), cooling fins for dissipating heat (1212), and tangs for engaging a lighting fixture (1214). On the inside of the extrusion resides the control circuit printed circuit board (1204) with the discreet circuit components (1206). A separate printed circuit board supports one or more LEDs (1218).

A further feature of the extrusion is the provision of opposing grooves (1210) that run parallel with the extrusion centerline. These grooves (1210) retain an optional lens, shade, or transparent covering (1208) that protects and/or filters the LED light.

In this embodiment, the extrusion is made from metal, preferably aluminum. However, any metal or plastic that may be extruded or otherwise machined is suitable for use and is within the scope of the invention. Further, such housing may be machined instead of extruded, and may be machined from not only metal and plastic but organic substances, such as wood.

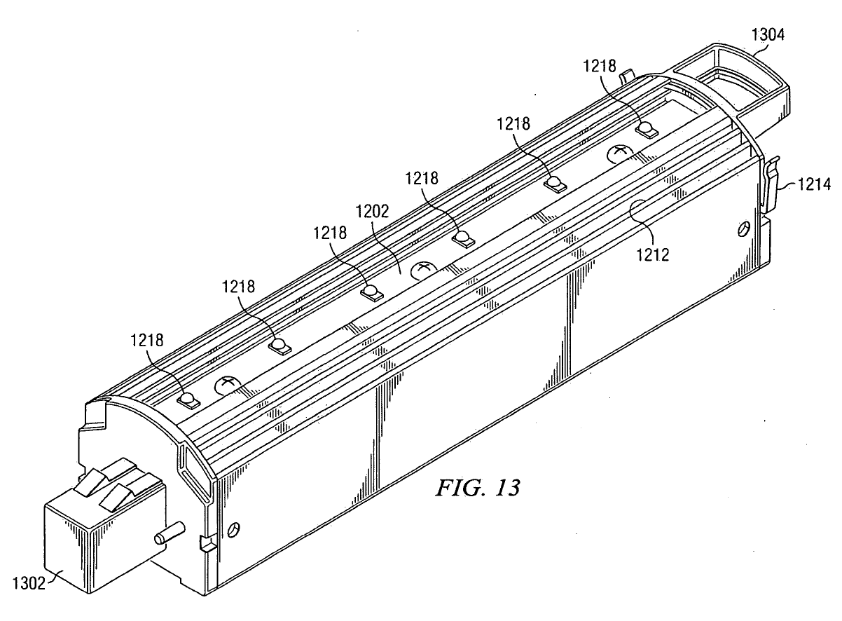

FIG. 13 depicts a perspective view of this embodiment to further highlight the GX23 type connector (1302). In this view it is shown the location and spacing of the multiple LED lights (1218). Because the device utilizes high-brightness LEDs, fewer LEDs are required to provide the desired illumination. Because fewer LEDs are needed, the spacing between the LEDs is increased which results in fewer point sources of light in a given fixture, with each point source being higher in intensity. By utilizing fewer point sources of light, the result is light that is more concentrated, accentuating the radiance of illuminated jewelry such as diamonds. In this figure, it can be seen that the assembly (1200) provides a finger-pull device (1304) to assist in removal of the assembly from a mounted position. The finger-pull (1304) improves grip upon the assembly (1200) when in the typical “C” shaped channel of a lighting fixture, and allows removal of an assembly that is hot due to operation.

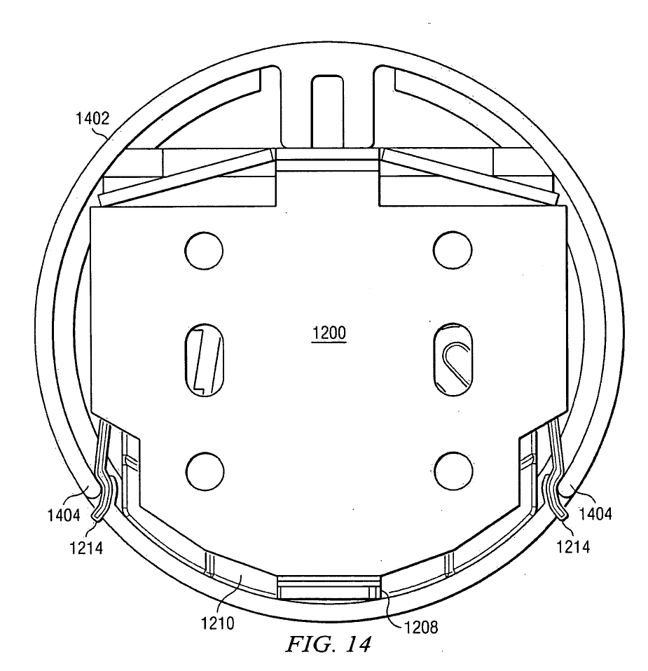

FIG. 14 depicts the LED lighting assembly (1200) as it mounts within a typical “C” shaped channel (1402) of a lighting fixture. Once the fluorescent light bulb is removed, the LED assembly (1200) is plugged into the supply fixture. The plug provides a physical connection that supports the plug end of the assembly (1200). The tangs (1214) on the opposite end of the assembly (1200) are then engaged with the opening (1404) of the fixture (1402) to provide physical support and easy installation and removal. Thus, to remove the assembly (1200) merely requires that, the user grip the two tangs (1214) simultaneously, squeezing toward the assembly body until the tangs disengage the “C” shaped channel (1402). The assembly (1200) will then drop down slightly at the tang-end and can then be pulled free from the socket and removed from the channel (1402).

In a typical display case, the light fixture channel (1402) is mounted near the top front or rear corner of the case with the light angled towards the case contents. Referring once more to FIG. 12, the present embodiment utilizes a novel design to direct the illumination cone (1222) to prevent glare. With the LED (1218) energized, light emanates in essentially a cone pattern. By offsetting the LED (1218) to one side of the circuit board (1202) (as shown in FIG. 12), and incorporating the glare shield (1220), the light (1222) is angled away from the viewer's eyes and more directly onto the surface being illuminated. Thus, as illustrated, the light (1222) emanates from the housing at a steeper angle to the left and a shallower angle to the right. If the light fixture and supply plug are such that the LED assembly (1200) must be mounted facing the opposite direction, the light (1222) angles can be reversed by removing and rotating the LED circuit board (1202). Such reversal places the LEDs (1218) on the opposite side of the centerline of the circuit board (1202) than that depicted in FIG. 12.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. An LED illumination device for retrofitting a fluorescent lighting fixture, the device comprising:
an electrical connector configured for mating with the socket of an existing lighting fixture in essentially the same manner as the original fluorescent bulb;
at least one LED;
a control circuit for powering the at least one LED from the original lighting fixture power source, the control circuit comprising:
an isolation circuit to physically isolate the original lighting fixture power source from the control circuit; and
a constant current regulator for providing current to the at least one LED; and
a housing, the housing comprising:
an internal cavity for containing the control circuit; and
an opening through which light from the at least one LED may exit.

2. The device of claim 1, the housing further comprising:
at least two tangs capable of engaging the opening of the lighting fixture, wherein the tangs allow releasable retention of the device within the fixture opening.

3. The device of claim 1, the control circuit further comprising:
a high voltage primary circuit that interfaces with the lighting fixture power source and is electrically isolated from a lower voltage secondary circuit that powers the at least one LED.

4. The device of claim 3, the control circuit further comprising:
a constant current source for powering the at least one LED.

5. The device of claim 4, the control circuit further comprising:
a voltage clamp to limit voltage in the event of an LED failure.

6. The device of claim 1, the housing further comprising:
a glare shield integral with the opening of the housing.

7. The device of claim 6, the device further comprising:
at least one LED mounting, wherein the at least one LED is affixed to the mounting such that the LED is offset from the centerline of the housing opening.

8. The device of claim 7 wherein the LED mounting may be rotated to place the LED offset on the other side of the centerline.

9. The device of claim 1 wherein the original lighting fixture utilizes a GX23-type base connector.

10. The device of claim 1 wherein the housing opening comprises a transparent or translucent covering.
